(19) United States
(12) Patent Application Publication
(10) Pub. No.: US 2026/0087472 A1
(43) Pub. Date: Mar. 26, 2026

(54) MANAGEMENT DEVICE FOR RETAIL TRANSACTION PROCESSING SYSTEMS AND METHOD

(71) Applicant: Toshiba Tec Kabushiki Kaisha, Tokyo (JP)

(72) Inventor: Yasuhiro KATABIRA, Tagata Shizuoka (JP)

(21) Appl. No.: 19/220,819

(22) Filed: May 28, 2025

(30) Foreign Application Priority Data
Sep. 25, 2024 (JP) 2024-166469

(51) Int. Cl. G06Q 20/20; G06F 9/455

(52) U.S. Cl. CPC G06Q 20/20; G06F 9/45558; G06F 2009/45562

(57) ABSTRACT

According to one embodiment, a management device for a retail transaction processing system has a first connection interface for connecting to a merchandise registration unit, a second connection interface for connecting to a first checkout unit, a third connection interface for connecting to a second checkout unit, a processor. The processor is configured to control the merchandise registration unit via the first connection interface to perform a merchandise registration process of a sales transaction, select between the first checkout unit and the second checkout out unit for a settlement process of the sales transaction, and then control the selected one of the first and second checkout units to perform the settlement process for the sales transaction. Control of the first or second checkout units may be provided in some examples by a virtual checkout machine or the like established by the management device.

### CROSS-REFERENCE TO RELATED APPLICATION

This application is based upon and claims the benefit of priority from Japanese Patent Application No. 2024-166469, filed Sep. 25, 2024, the entire contents of which are incorporated herein by reference.

### FIELD

Embodiments described herein relate generally to an a management device for retail transaction processing systems and an information processing method for such devices and systems.

### BACKGROUND

In the related art, a system including a plurality of user terminals is known. In such a system, equipment may be shared among a plurality of users. In such cases, a separate operating system (OS) and specific hardware controls for the OS may have to be prepared for each individual terminal. The system may thus comprise multiple computers and execute various processes of the system by network communication or the like between the different terminals.

However, when separate hardware is required for each user terminal, a larger installation space is required to accommodate the system.

### BRIEF DESCRIPTION OF THE DRAWINGS

FIG. 1 is a diagram of a point of sales (POS) system according to an embodiment.

FIG. 2 is a diagram showing an example of a system configuration.

FIG. 3 is a diagram showing an example of a hardware configuration of a management device.

FIG. 4 is a block diagram showing a schematic example of a functional configuration of a management device.

FIG. 5 is a flowchart showing an example of a sales data process executed by a POS system.

### DETAILED DESCRIPTION

In an embodiment, a system for retail checkout processing is provided by which functions of different user terminals are provided by shared hardware rather than requiring separate hardware for each terminal.

In general, according to one embodiment, a management device for a retail transaction processing system has a first connection interface for connecting to a merchandise registration unit, a second connection interface for connecting to a first checkout unit, a third connection interface for connecting to a second checkout unit, a processor. The processor is configured to control the merchandise registration unit via the first connection interface to perform a merchandise registration process of a sales transaction, select between the first checkout unit and the second checkout out unit for a settlement process of the sales transaction, and control the selected one of the first and second checkout units to perform the settlement process for the sales transaction.

Hereinafter, certain example embodiments of an information processing device and an information processing method will be described with reference to the accompanying drawings. The specific example embodiments described below do not limit the present disclosure.

### Example Embodiment

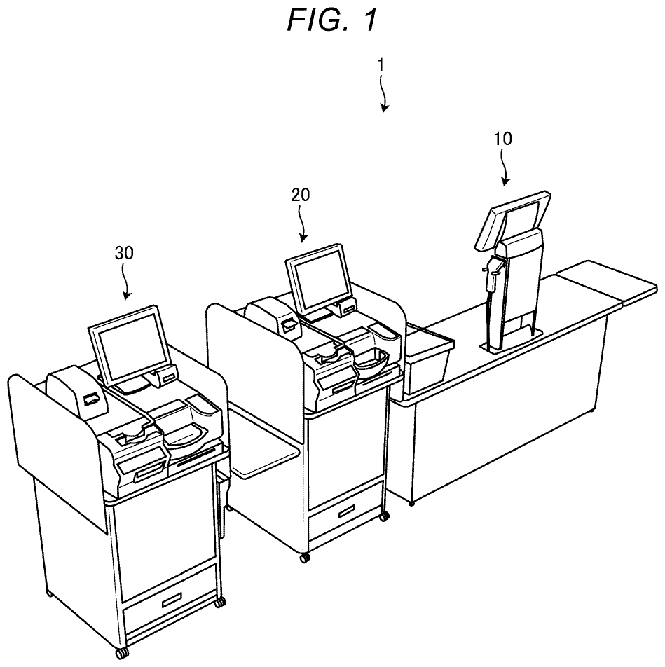

FIG. 1 is a diagram showing an example of a point of sales (POS) system 1 according to an embodiment. The POS system 1 includes a merchandise registration unit 10, a first checkout unit 20, and a second checkout unit 30.

The POS system 1, as depicted, is a so-called semi-self-checkout system. That is, the POS system 1 is a checkout system in which a merchandise registration process is executed by a store clerk at merchandise registration unit 10, and a checkout (settlement) process of paying for the merchandise registered in the merchandise registration process is performed by the customer at one of the checkout units (e.g., first checkout unit 20 or second checkout unit 30).

The merchandise registration unit 10 functions as a terminal used in the merchandise registration process. In this context, the merchandise registration process can be a process such as scanning each item to be purchased. In the present example, the merchandise registration unit 10 is operated by the store clerk rather than the customer.

The first checkout unit 20 and the second checkout unit 30 function as terminals used for paying the price of the merchandise registered in the merchandise registration process. In this example, the first checkout unit 20 and the second checkout unit 30 are operated by the customer.

In general, either the first checkout unit 20 or the second checkout unit 30 may be used by the customer. However, when one or the other of the first checkout unit 20 or the second checkout unit 30 is in use, the other one of the first checkout unit 20 and the second checkout unit 30 is to be used when available. In the following description when the first checkout unit 20 and the second checkout unit 30 are not being distinguished from one another, either may be referred to more simply as a checkout unit.

In a self-checkout system in the related art, a merchandise registration device that executes the merchandise registration process and a checkout device that executes the checkout process can be separate terminal devices. That is, the merchandise registration device and the checkout device each separately include or comprise a computer that controls the respective operations of the devices. In such related art systems, the merchandise registration device and the checkout device function in the system by transmitting and receiving information across a network connection or the like to one another between the distinct terminal (computer) devices.

However, when separate computers are used for each of the respective merchandise registration device and checkout devices, the self-checkout system requires a larger installation space. There is generally a demand for a self-checkout system that can be installed in a smaller installation space.

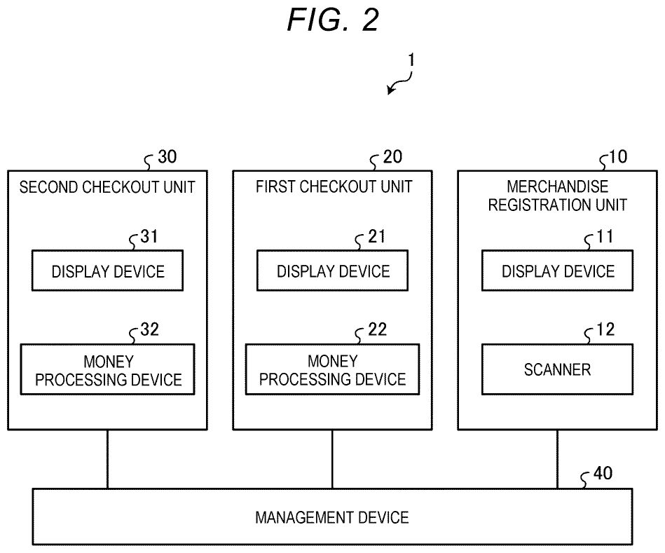

FIG. 2 is a diagram showing an example of a system configuration of the POS system 1 according to the present embodiment. The POS system 1 includes the merchandise registration unit 10, the first checkout unit 20, the second checkout unit 30, and a management device 40 that controls these units.

The merchandise registration unit 10 comprises devices (equipment) used in the merchandise registration process. The first checkout unit 20 and the second checkout unit 30 each include devices (equipment) used in the checkout process.

The management device 40 is connected to the merchandise registration unit 10, the first checkout unit 20, and the second checkout unit 30. The merchandise registration process may be referred to as a first process in some instances. The checkout process may be referred to as a second process in some instances. The merchandise registration unit 10 is an example of a first unit. The first checkout unit 20 is an example of a second unit. The second checkout unit 30 is an example of a third unit.

It is the management device 40 that controls the merchandise registration unit 10, the first checkout unit 20, and the second checkout unit 30. More specifically, the management device 40 executes the information processing associated with the merchandise registration process at the merchandise registration unit 10. The management device 40 makes the selection (designation) of the first checkout unit 20 or the second checkout unit 30 to be used by a customer after the merchandise registration process. The management device 40 then executes the information processing associated with the checkout process at the selected checkout unit.

The merchandise registration unit 10 includes a display device 11 and a scanner 12. The merchandise registration unit 10 is not limited to these particular devices and other devices may be included, in addition or instead of these devices. In other examples, the merchandise registration unit 10 may include an input device such as a keyboard or another device.

The display device 11 is a device such as a liquid crystal display or an organic electro luminescence (EL) display. The display device 11 may be a touch panel display. For example, the display device 11 displays images related to the merchandise registration process based on the control of the management device 40.

The scanner 12 is a device that reads a code symbol such as a barcode corresponding to a merchandise code for specifying/identifying merchandise being purchased. The scanner 12 transmits the read/acquired merchandise code to the management device 40.

The first checkout unit 20 includes a display device 21 and a money processing device 22. The first checkout unit 20 is not limited to these devices. In other examples, the first checkout unit 20 may include other devices, in addition or instead, such as a settlement terminal by which a payment can be executed using a credit card, electronic money, or the like. An input device such as a keyboard or the like may also be included in some examples.

The display device 21 is a device such as a liquid crystal display or an organic EL display. The display device 21 may be a touch panel display. For example, the display device 21 displays images related to the checkout process based on the control of the management device 40.

The money processing device 22 is a device that receives money for paying the price of registered merchandise and discharges change as appropriate. In general, the money processing device 22 discharges the change based on the control of the management device 40.

The second checkout unit 30 includes a display device 31 and a money processing device 32. The second checkout unit 30 is not limited to these devices. In other examples, the first checkout unit 20 may include other devices, in addition or instead, such as a settlement terminal by which a payment can be executed using a credit card, electronic money, or the like. An input device such as a keyboard or the like may also be included in some examples.

The display device 31 is a device such as a liquid crystal display or an organic EL display. The display device 31 may be a touch panel display. For example, the display device 31 displays images related to the checkout process based on the control of the management device 40.

The money processing device 32 is a device that receives money for paying the price of registered merchandise and discharges change as appropriate. In general, the money processing device 32 discharges the change based on the control of the management device 40.

In such a configuration, the management device 40 controls the merchandise registration unit 10 as a peripheral device. In some examples, the management device 40 controls the first checkout unit 20 as or by a virtual machine. Similarly, the management device 40 controls the second checkout unit 30 as or by a virtual machine.

Next, the management device 40 will be described.

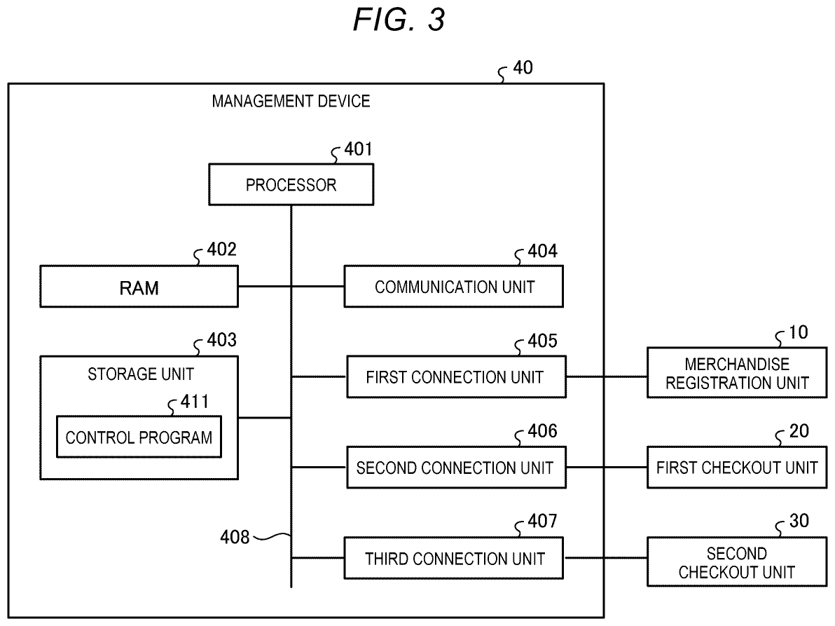

FIG. 3 is a diagram showing an example of a hardware configuration of the management device 40 according to the present embodiment. The management device 40 includes a processor 401, a RAM 402, a storage unit 403, a communication unit 404, a first connection unit 405, a second connection unit 406, and a third connection unit 407. These units are connected to one another via an internal bus 408.

The processor 401 is a processing circuit, such as a CPU, that controls operations of the management device 40. The RAM 402 is a storage medium that temporarily stores various programs and various types of data. The processor 401 executes a control program 411 and the like stored in the storage unit 403 using the RAM 402 as a work area (working region).

The storage unit 403 is an auxiliary storage device such as a hard disk drive (HDD), a solid state drive (SSD), or a flash memory. The storage unit 403 stores the control program 411.

The control program 411 is a program for implementing the described functions of the management device 40. The control program 411 includes program instructions for implementing described functions according to an embodiment.

The communication unit 404 is a wired communication device such as a network interface card. For example, the communication unit 404 executes communication with external devices (not shown) via a local area network (LAN) cable.

The first connection unit 405 is an interface for connecting (a connection interface) to the merchandise registration unit 10. For example, the first connection unit 405 comprises, or is, a physical connector such as a universal serial bus (USB) Type-C connector. The first connection unit 405 is not limited to a USB type. The first connection unit 405 may comprise a plurality of interfaces (I/O connectors or connections) according to the individual devices of the merchandise registration unit 10. For example, the first connection unit 405 may include an interface such as a High Definition Multimedia Interface (HDMI) or a DisplayPort connector or connection. The first connection unit 405 may incorporate an interface such as a wired LAN or a wireless LAN for connecting to equipment of the merchandise registration unit 10.

The second connection unit 406 is an interface for connecting (a connection interface) to the first checkout unit 20. For example, the second connection unit 406 is a physical interface such as a USB Type-C connector or connection. The second connection unit 406 is not limited to a USB type. The second connection unit 406 may comprise a plurality of interfaces (I/O connectors or connections) according to the individual devices of the first checkout unit 20. For example, the second connection unit 406 may include an interface such as a HDMI or a DisplayPort connector or connection. The second connection unit 406 may incorporate an interface such as a wired LAN or a wireless LAN for connecting to equipment of the first checkout unit 20.

The third connection unit 407 is an interface for connecting (a connection interface) to the second checkout unit 30. For example, the third connection unit 407 is a physical interface such as a USB Type-C connector or connection. The third connection unit 407 is not limited to a USB type. The third connection unit 407 may comprise a plurality of interfaces (I/O connectors or connections) according to the individual devices of the second checkout unit 30. For example, the third connection unit 407 may include an interface such as a HDMI or a DisplayPort connector or connection. The third connection unit 407 may incorporate an interface such as a wired LAN or a wireless LAN for connecting to equipment of the second checkout unit 30.

Next, the functions and operations of the management device 40 will be described.

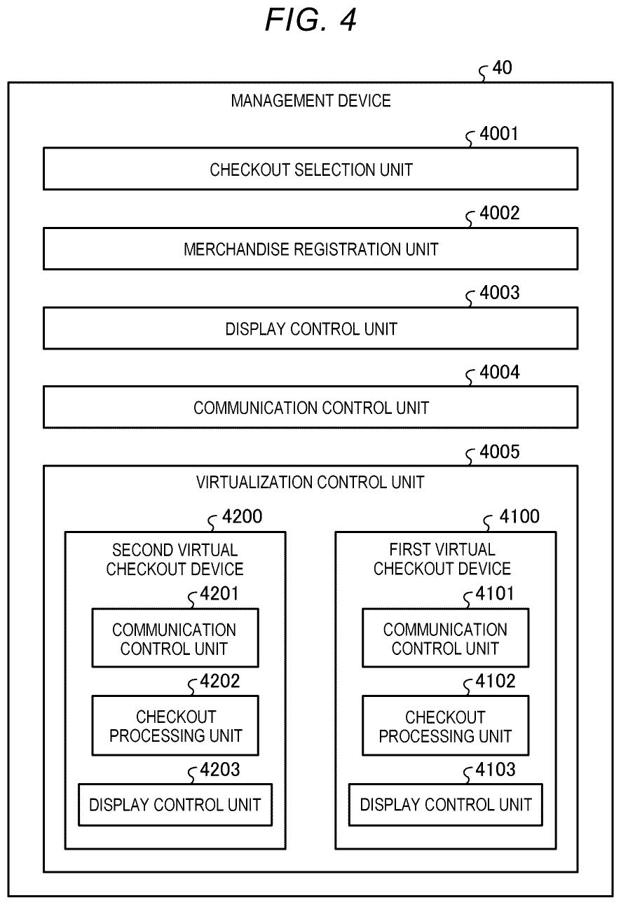

FIG. 4 is a block diagram showing a schematic example of a functional configuration of the management device 40 according to an embodiment. For example, the processor 401 in the management device 40 can be considered to load the control program 411 stored in the storage unit 403 into the RAM 402 and operate according to the control program 411 to generate these functional units in the RAM 402 or the like. The processor 401 in the management device 40 accordingly provides, as functional units, a checkout selection unit 4001, a merchandise registration unit 4002, a display control unit 4003, a communication control unit 4004, and a virtualization control unit 4005.

The checkout selection unit 4001 selects between either the first checkout unit 20 or the second checkout unit 30 as the checkout unit to be used in the checkout process. The checkout selection unit 4001 is an example of a selection unit. Here, the checkout selection unit 4001 selects which virtual machine between a first virtual checkout device 4100 or a second virtual checkout device 4200 is to be used to execute the checkout process.

Here, the POS system 1 includes two checkout units (the first checkout unit 20 and the second checkout unit 30). Therefore, when the first checkout unit 20 is already in use, the second checkout unit 30 can be used. Therefore, when a merchandise registration process ends, the checkout selection unit 4001 switches between the first checkout unit 20 and the second checkout unit 30 to be used in the checkout process.

Here, when a checkout unit is already in use, another customer cannot use the checkout unit even if this in-use checkout unit is selected by the checkout selection unit 4001. In addition, a checkout unit may be out of service due to a failure or maintenance issue such as being out of change or the like. Therefore, the checkout selection unit 4001 selects either the first checkout unit 20 or the second checkout unit 30 according to the respective operating states of the first checkout unit 20 and the second checkout unit 30.

For example, the checkout selection unit 4001 selects a checkout unit that is not in use or out of service. When all checkout units are in use and not out of service, the checkout selection unit 4001 waits. That is, the checkout selection unit 4001 waits until a selection condition for selecting a checkout unit to be used in the checkout process is satisfied. When there is a checkout unit that is not in use and is not out of service, the checkout selection unit 4001 determines that a selection condition is satisfied and selects the available (and operable) checkout unit to be used in the checkout process.

The merchandise registration unit 4002 controls the merchandise registration unit 10 to execute the merchandise registration process. The merchandise registration unit 4002 is an example of a first functional unit. For example, the merchandise registration unit 4002 triggers or permits the scanner 12 to read a merchandise code on an item of merchandise being purchased. The merchandise registration unit 4002 acquires information about merchandise that is specified by the merchandise code read by the scanner 12. The information can be provided in a merchandise master in which the information on the merchandise such as a product name and a price is associated with the merchandise codes. In other words, the merchandise registration unit 4002 registers the merchandise specified by the merchandise code read by the scanner 12 in a sales transaction. The merchandise registration unit 4002 generates merchandise registration information including the merchandise information of the items registered in the sales transaction.

The display control unit 4003 displays images related to the merchandise registration process on the display device 11 of the merchandise registration unit 10. For example, the display control unit 4003 displays a merchandise registration image providing a list of items registered in the merchandise registration process on the display device 11 of the merchandise registration unit 10.

The communication control unit 4004 communicates with a virtual machine. That is, the communication control unit 4004 communicates with the first virtual checkout device 4100, which is a virtual machine controlling the first checkout unit 20. The communication control unit 4004 also communicates with the second virtual checkout device 4200, which is a virtual machine controlling the second checkout unit 30.

More specifically, the communication control unit 4004 transmits a merchandise registration process result to the first virtual checkout device 4100 that controls the first checkout unit 20 or the second virtual checkout device 4200 that controls the second checkout unit 30. For example, the communication control unit 4004 transmits the merchandise registration information generated by the merchandise registration unit 4002 as a processing result of the merchandise registration process.

For example, when a user operation for ending the merchandise registration process is received at the merchandise registration unit 10, the communication control unit 4004 transmits the merchandise registration information for items registered in the merchandise registration process.

The virtualization control unit 4005 controls the first checkout unit 20 and the second checkout unit 30 by functions of the respective virtual machines. The virtualization control unit 4005 includes a first virtual checkout device 4100 and a second virtual checkout device 4200.

The first virtual checkout device 4100 is a virtual machine that controls the first checkout unit 20. The first virtual checkout device 4100 executes an operating system (OS) such as Windows®. The first virtual checkout device 4100 also executes various applications as appropriate on the OS. By executing these various applications, the first virtual checkout device 4100 provides a communication control unit 4101, a checkout processing unit 4102, and a display control unit 4103.

The communication control unit 4101 communicates with the communication control unit 4004. For example, the communication control unit 4101 acquires the merchandise registration information transmitted from the communication control unit 4004.

The checkout processing unit 4102 controls the first checkout unit 20 to execute the checkout process. More specifically, when the first checkout unit 20 is selected by the checkout selection unit 4001, the checkout processing unit 4102 executes the checkout process for the items registered in the merchandise registration process. That is, based on the merchandise registration information acquired by the communication control unit 4101, the checkout processing unit 4102 acquires or calculates a total merchandise price by summing prices of all the individual items registered in the merchandise registration process.

The checkout processing unit 4102 determines whether money (payment) equal to or greater than the acquired total merchandise price has been inserted into the money processing device 22 of the first checkout unit 20. When the money equal to or greater than the total merchandise price is inserted, the checkout processing unit 4102 calculates the change due. Then, the checkout processing unit 4102 causes the money processing device 22 of the first checkout unit 20 to discharge the calculated change due. In this way, the checkout processing unit 4102 executes a checkout process.

The display control unit 4103 displays images related to the checkout process on the display device 21 of the first checkout unit 20. For example, the display control unit 4103 displays an image including the total merchandise price as acquired or calculated by the checkout processing unit 4102. The display control unit 4103 also displays an image indicating the money inserted into the money processing device 22 of the first checkout unit 20 and the change due as calculated by the checkout processing unit 4102.

The second virtual checkout device 4200 is a virtual machine that controls the second checkout unit 30. The second virtual checkout device 4200 executes an OS such as Windows®. The second virtual checkout device 4200 also executes various applications on the OS as appropriate. By executing the various applications, the second virtual checkout device 4200 provides a communication control unit 4201, a checkout processing unit 4202, and a display control unit 4203.

The communication control unit 4201 communicates with the communication control unit 4004. For example, the communication control unit 4201 acquires merchandise registration information transmitted from the communication control unit 4004.

The checkout processing unit 4202 controls the second checkout unit 30 to execute a checkout process. More specifically, when the second checkout unit 30 is selected by the checkout selection unit 4001, the checkout processing unit 4202 executes the checkout process based on the merchandise registration process result. That is, based on the merchandise registration information acquired by the communication control unit 4201, the checkout processing unit 4202 acquires a total merchandise price by summing the prices of all the individual items registered in the merchandise registration process.

The checkout processing unit 4202 determines whether money equal to or greater than the acquired total merchandise price has been inserted into the money processing device 22 of the second checkout unit 30. When money equal to or greater than the total merchandise price has been inserted, the checkout processing unit 4202 calculates the change due. Then, the checkout processing unit 4202 causes the money processing device 22 to discharge the calculated change due. In this way, the checkout processing unit 4202 executes a checkout process.

The display control unit 4203 displays images related to the checkout process on the display device 31 of the second checkout unit 30. For example, the display control unit 4203 displays an image indicating the total merchandise price as acquired or calculated by the checkout processing unit 4202. The display control unit 4203 displays an image indicating the money inserted into the money processing device 22 of the second checkout unit 30 and an image indicating the change due as calculated by the checkout processing unit 4202.

Next, a sales data process executed by the POS system 1 will be described.

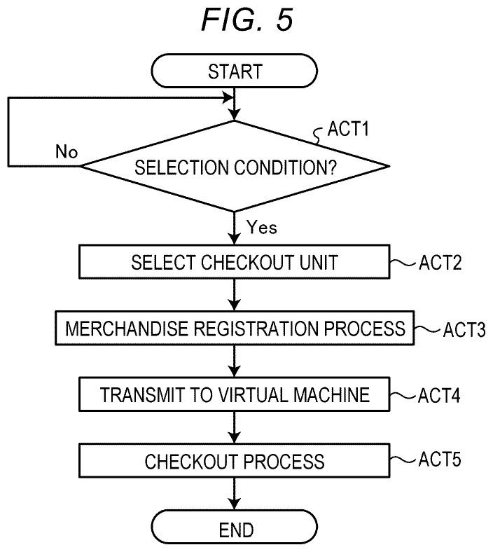

FIG. 5 is a flowchart showing an example of the sales data process executed by the POS system 1 according to an embodiment.

First, checkout selection unit 4001 determines whether a selection condition for selecting a checkout unit is satisfied (ACT1). That is, the checkout selection unit 4001 determines whether a checkout unit is available/usable. If not satisfied (No in ACT1), the checkout selection unit 4001 waits.

If the selection condition is satisfied (Yes in ACT1), the checkout selection unit 4001 selects a checkout unit to be used in the checkout process (ACT2). That is, the checkout selection unit 4001 selects one of the first virtual checkout device 4100 or the second virtual checkout device 4200.

The merchandise registration unit 4002 executes a merchandise registration process using the merchandise registration unit 10 (ACT3).

The communication control unit 4004 transmits the merchandise registration information generated by the merchandise registration process to the virtual machine that controls the checkout unit selected by the checkout selection unit 4001 (ACT4). That is, the checkout selection unit 4001 transmits the merchandise registration information to a selected one of the first virtual checkout device 4100 and the second virtual checkout device 4200.

The checkout processing unit 4102 or checkout processing unit 4202 executes a checkout process at the selected/corresponding checkout unit based on the merchandise registration information (ACT5).

Subsequently, the POS system 1 ends the sales data processing.

As described above, the management device 40 according to an embodiment is connected to the merchandise registration unit 10, the first checkout unit 20, and the second checkout unit 30. The management device 40 selects which of the first checkout unit 20 or the second checkout unit 30 is to be used in the checkout process. The management device 40 transmits the merchandise registration information including the merchandise information of the items registered in the merchandise registration process to a virtual machine that controls the selected checkout unit. As described above, the first checkout unit 20 and the second checkout unit 30 are controlled by different respective virtual machines, and thus each checkout unit may include different hardware. However, a dedicated, separate physical computer is not required for each checkout unit. Therefore, the management device 40 allows the POS system 1 to be installed in a relatively small space by sharing certain hardware between the checkout units.

### Modification 1

In the above example embodiment, the processor 401 of the management device 40 operates according to a control program 411 to implement the functions of the merchandise registration unit 4002, the display control unit 4003, and the communication control unit 4004. However, in other examples, the merchandise registration unit 4002, the display control unit 4003, and the communication control unit 4004 may be provided in a virtual machine. That is, each of the first virtual checkout device 4100 and the second virtual checkout device 4200 of the virtualization control unit 4005 may themselves provide such functions.

In this case, the checkout selection unit 4001 selects which of the first checkout unit 20 or the second checkout unit 30 is to be used in the checkout process. That is, the checkout selection unit 4001 selects which of the first virtual checkout device 4100 or the second virtual checkout device 4200 is used to execute the checkout process.

The checkout selection unit 4001 establishes an internal connection (communication path) between the selected virtual machine and the devices (equipment) of the merchandise registration unit 10. The checkout selection unit 4001 maintains the internal connection between the selected virtual machine and the merchandise registration unit 10 until the merchandise registration process is completed.

When the first virtual checkout device 4100 is selected, the checkout selection unit 4001 establishes an internal connection between the first virtual checkout device 4100 and the devices (equipment) of the merchandise registration unit 10. The first virtual checkout device 4100 controls the merchandise registration unit 10 or its devices to execute the merchandise registration process. That is, the merchandise registration unit 4002 in the first virtual checkout device 4100 controls the merchandise registration unit 10 by communication via the communication control unit 4004 to execute the merchandise registration process. The display control unit 4003 of the first virtual checkout device 4100 displays images related to the merchandise registration process on the display device 11 of the merchandise registration unit 10 by communication via the communication control unit 4004.

The checkout selection unit 4001 ends the internal connection once the merchandise registration process is completed. Then, the checkout selection unit 4001 selects a virtual machine for executing the merchandise registration process of the next transaction. The checkout processing unit 4102 executes the checkout process based on the results of the merchandise registration process.

On the other hand, when the second virtual checkout device 4200 is selected, the checkout selection unit 4001 establishes an internal connection between the second virtual checkout device 4200, and the devices (equipment) of the merchandise registration unit 10. The second virtual checkout device 4200 controls the devices (equipment) of the merchandise registration unit 10 to execute a merchandise registration process. That is, the merchandise registration unit 4002 in the second virtual checkout device 4200 controls the merchandise registration unit 10 by communication via the communication control unit 4004 to execute the merchandise registration process. The display control unit 4003 in the second virtual checkout device 4200 displays images related to the merchandise registration process on the display device 11 of the merchandise registration unit 10 by communication via the communication control unit 4004.

The checkout selection unit 4001 ends the internal connection once the merchandise registration process is completed. Then, the checkout selection unit 4001 selects a virtual machine for executing a merchandise registration process for the next transaction. The checkout processing unit 4202 then executes the checkout process based on the results of the merchandise registration process.

A program executed by a device in an embodiment may be provided by being incorporated in advance in a storage medium (the ROM or the storage unit), but is not limited thereto. For example, the program may be provided by being recorded in a non-transitory, computer-readable recording medium such as a CD-ROM, a flexible disk (FD), a CD-R, or a digital versatile disk (DVD) in a file in an installable or executable format. Such a program may be transmitted by a LAN, the Internet, or the like an stored or accessed thereby.

A program executed an embodiment may be stored in a computer connected to a network such as the Internet and provided by being downloaded via the network, or may be provided or distributed via the network such as the Internet.

While certain embodiments have been described, these embodiments have been presented by way of examples only, and are not intended to limit the scope of the disclosure. These novel embodiments can be implemented in various other forms, and various omissions, substitutions, and modifications can be made without departing from the gist of the disclosure. The embodiments and the modifications thereof are included in the scope and the gist of the disclosure, and are included in the scope of the disclosure disclosed in the claims and equivalents thereof.

What is claimed is:

1. A management device for a retail transaction processing system, the management device comprising:
a first connection interface for connecting to a merchandise registration unit;
a second connection interface for connecting to a first checkout unit;
a third connection interface for connecting to a second checkout unit; and
a processor configured to:
control the merchandise registration unit via the first connection interface to perform a merchandise registration process of a sales transaction;
select between the first checkout unit and the second checkout out unit for a settlement process of the sales transaction; and
control the selected one of the first and second checkout units to perform the settlement process for the sales transaction.

2. The management device according to claim 1, wherein
the processor is further configured to establish a virtual machine corresponding to the selected one of the first and second checkout units, and
the selected one of the first and second checkout units is controlled by the virtual machine to perform the settlement process for the sales transaction.

3. The management device according to claim 2, wherein the processor is configured to provide a merchandise registration result from the merchandise registration process to the virtual machine.

4. The management device according to claim 2, wherein the processor is configured to provide a communication connection between the merchandise registration unit and the virtual machine.

5. The management device according to claim 1, wherein the processor is further configured to:
establish a first virtual checkout device corresponding to the first checkout unit; and
establish a second virtual checkout device corresponding to the second checkout unit.

6. The management device according to claim 5, wherein a merchandise registration result from the merchandise registration process is sent to the one of the first or second virtual checkout devices corresponding to the selected one of the first or second checkout units.

7. The management device according to claim 5, wherein the first and second checkout units are controlled by the corresponding first and second virtual checkout devices to perform the settlement process for the sales transaction.

8. The management device according to claim 5, wherein the processor is further configured to:
select one of the first or second virtual checkout devices to control the merchandise registration unit via the first connection interface to perform the merchandise registration process of the sales transaction.

9. A retail transaction processing system, comprising:
a merchandise registration unit including:
a product scanner, and
a registration display device;
a first checkout unit including:
a first checkout display device, and
a first payment processing device;
a second checkout unit including:
a second checkout display device, and
a second payment processing device;
a management device including:
a first connection interface connected to the merchandise registration unit,
a second connection interface connected to the first checkout unit,
a third connection interface connected to the second checkout unit, and
a processor configured to:
control the merchandise registration unit via the first connection interface to perform a merchandise registration process of a sales transaction,
select between the first checkout unit and the second checkout out unit for a settlement process of the sales transaction, and
control the selected one of the first and second checkout units to perform the settlement process for the sales transaction.

10. The retail transaction processing system according to claim 9, wherein
the first connection interface comprises a USB-type connector,
the second connection interface comprises a USB-type connector, and
the third connection interface comprises a USB-type connector.

11. The retail transaction processing system according to claim 9, wherein
the processor is further configured to establish a virtual machine corresponding to the selected one of the first and second checkout units, and
the selected one of the first and second checkout units is controlled by the virtual machine to perform the settlement process for the sales transaction.

12. The retail transaction processing system according to claim 11, wherein the processor is configured to provide a merchandise registration result from the merchandise registration process to the virtual machine.

13. The retail transaction processing system according to claim 11, wherein the processor is configured to provide a communication connection between the merchandise registration unit and the virtual machine.

14. The retail transaction processing system according to claim 9, wherein the processor is further configured to:
establish a first virtual checkout device corresponding to the first checkout unit; and
establish a second virtual checkout device corresponding to the second checkout unit.

15. The retail transaction processing system according to claim 14, wherein a merchandise registration result from the merchandise registration process is sent to the one of the first or second virtual checkout devices corresponding to the selected one of the first or second checkout units.

16. The retail transaction processing system according to claim 14, wherein the first and second checkout units are controlled by the corresponding first and second virtual checkout devices to perform the settlement process for the sales transaction.

17. The retail transaction processing system according to claim 14, wherein the processor is further configured to:
select one of the first or second virtual checkout devices to control the merchandise registration unit via the first connection interface to perform the merchandise registration process of the sales transaction.

18. A method for a retail transaction processing system, the method comprising:
establishing, in a management device, a first virtual checkout device corresponding to a first checkout unit connected to the management device via a first checkout interface connection;
establishing, in the management device, a second virtual checkout device corresponding to a second checkout unit connected to the management device via a second checkout interface connection;
controlling a merchandise registration unit via a first connection interface to perform a merchandise registration process of a sales transaction;
selecting between the first checkout unit and the second checkout out unit for a settlement process of the sales transaction; and
controlling the selected one of the first and second checkout units to perform the settlement process for the sales transaction via the corresponding one of the first and second virtual checkout devices.

19. The method according to claim 18, wherein a merchandise registration result from the merchandise registration process is sent to the one of the first or second virtual checkout devices corresponding to the selected one of the first or second checkout units.

20. The method according to claim 18, wherein the one of the first or second virtual checkout devices corresponding to the selected one of the first or second checkout units controls the merchandise registration unit for the merchandise registration process of the sale transaction.
